(19) United States
(12) Patent Application Publication
(10) Pub. No.: US 2026/0028490 A1
(43) Pub. Date: Jan. 29, 2026

(54) STABILISED MINERAL SUSPENSION

(71) Applicant: COATEX, Genay (FR)

(72) Inventors: Christian JACQUEMET, Lyon (FR); Laurie PARRENIN, Villeneuve (FR); Morgane LE NEINDRE, Curis-au-Mont-d’Or (FR)

(73) Assignee: COATEX, Genay (FR)

(21) Appl. No.: 18/857,237

(22) PCT Filed: Apr. 25, 2023
(86) PCT No.: PCT/FR2023/000049

§ 371 Date: Oct. 16, 2024

(30) Foreign Application Priority Data
Apr. 27, 2022 (FR) FR2203938

(51) Int. Cl. C09D 7/40; C09D 133/14; D21H 17/37; D21H 17/67

(52) U.S. Cl. CPC C09D 7/69; C09D 133/14; D21H 17/37; D21H 17/675

(57) ABSTRACT

An aqueous suspension of a mineral material, for example calcium carbonate, may be prepared by wet grinding in the presence of an aqueous dispersion of (meth)acrylic polymer neutralized by a combination of at least one monovalent ion and at least one divalent ion, and post-grinding concentration. The particle size distribution and the viscosity and stability of the suspension may be particularly well controlled. Such a polymer may be an agent for facilitating grinding. Such a mineral suspension may be used for preparing a mass filler for paper production, for preparing a paper coating slip, or for preparing a coating composition, for example a paint composition.

The invention provides an aqueous suspension of a mineral material, for example calcium carbonate, which is prepared by wet grinding in the presence of an aqueous dispersion of (meth)acrylic polymer neutralised by means of a combination of at least one monovalent ion and of at least one divalent ion, then concentration after grinding. The particle size distribution and viscosity of the suspension according to the invention are particularly well controlled. The invention also relates to a grinding aid agent as well as to the use of this mineral suspension for the preparation of a mass filler for papermaking or of a paper coating colour or even for the preparation of a coating composition, for example a paint composition.

There are known methods for preparing suspensions of mineral materials. In particular, there are known methods that use grinding aid agents, in particular to control the rheology of the suspension when preparing it or when it is stored.

In general, the methods used to grind mineral materials must be efficient and enable the particle size distribution of the particles obtained to be controlled, particularly so that the suspension obtained has a narrow particle size distribution characterised by a high slope factor. Furthermore, the mineral material grinding methods must have a high efficacy in terms of grinding time for a particular grain size and for a defined amount of mineral material. In fact, when preparing a defined amount of mineral particles of a particular grain size, reducing the operating time of the grinding equipment improves the overall yield of the grinding method.

Likewise, it is important to have methods for grinding mineral material that make it possible to prepare aqueous suspensions of particles of mineral material that are stable not only shortly after preparation, but also several hours or days later. Viscosity drift phenomena must be controlled because they can lead to gelation of the prepared suspensions which would make handling difficult or impossible. Likewise, particle settling phenomena must be avoided or substantially slowed. In addition to controlling the stability, it is also essential to control the viscosity of the aqueous suspensions of particles of ground mineral material.

It is also important to be able to prepare aqueous suspensions of particles of mineral material with a high solids content. A high solids content of these aqueous suspensions of particles of mineral material makes it possible in particular to increase the productivity of the methods that use these suspensions and to limit the costs and resources required to convey these suspensions.

Moreover, it should be possible to prepare grinding aid agents in the absence of any compounds that could be considered harmful from an environmental standpoint or in the absence of any compounds that are restricted for use by regulatory provisions. In particular, preparing these agents in the absence of any compound comprising phosphorus should be preferred, especially the absence of any phosphorus in oxidation state I, III or V.

Furthermore, during papermaking, aqueous mineral filler compositions are used to provide a mineral filler within the pulp comprising water and fibres of vegetable origin, in particular fibres of cellulosic material. Within these compositions, the mineral filler is in the form of particles. The use of such mineral fillers makes it possible in particular to improve the physical properties of the paper, in particular to improve its optical properties, or to reduce the relative amount of cellulosic material in relation to the amount of mineral filler. Improving the efficacy of papermaking methods is also made possible through the use of these mineral fillers. The formation of flocs of mineral filler particles or of fibres that impair the quality of the paper must be limited. The ability to prepare suspensions of particles with a narrow size distribution must also be sought to improve the quality of coated paper using these suspensions. In particular, limiting the fraction of very fine particles then makes it possible to improve the opacity of the coated paper. Improving the uniformity of the particle size distribution should therefore be sought.

Improving the compatibility of the various compounds used in the preparation of paper should also be sought.

Document WO2012066308 relates to filled and coated paper preparation compositions that comprise microfibrillated cellulose and a particulate mineral material. Document WO2010131016 describes the preparation of an aqueous suspension of microfibrillated cellulose in the presence of a particulate mineral material. Document WO2016115393 relates to a method for treating a sulphur-containing fluid to produce gypsum and magnesium carbonate. Document WO2014062476 describes a coating composition comprising calcium carbonate particles and kaolin with a form factor of less than 70. Document CA2403878 describes acrylic copolymers prepared in the presence of a sulphur compound and then modified by reaction with a polyalkylene glycol. Document CA2518622 describes the use of polyacrylic acids with sulphur terminal groups for wet grinding calcium carbonate.

Thus, although there are methods for wet grinding mineral material using polymers as grinding aid agents, the methods in the prior art do not always make it possible to provide a satisfactory solution to the problems encountered with the aqueous mineral suspensions obtained. There is therefore a need for improved aqueous suspensions of mineral material. The invention makes it possible to provide a solution to all or part of the problems of the suspensions in the prior art.

Thus, the invention provides an aqueous suspension S of mineral particles with a concentration ranging from 65 to 80% by weight and with a slope factor E of the mass distribution of particle sizes [(d30/d70)×100], measured by sedimentation analysis, that is greater than 30, which is prepared:
by grinding in water at a concentration ranging from 30 to 60% by weight of an aqueous suspension Sd of at least one particulate mineral material M in the presence of an aqueous dispersion D comprising at least one α-sulphonated polymer P with a molecular mass by weight (Mw), measured by SEC, comprised between 4,000 and 20,000 g/mol and
prepared in water and in the absence of any phosphorus compound, by a polymerisation reaction of at least one monomer A chosen among acrylic acid, methacrylic acid, an acrylic acid salt, a methacrylic acid salt and combinations thereof, in the presence of at least one initiator compound and of at least one sulphur compound T comprising sulphur in oxidation state IV (sulphur IV or S^{IV}), and
completely or partially neutralised by means of a combination of at least one monovalent ion and of at least one divalent ion, then
concentration of the ground suspension Sd.

Sedimentation analysis is a method of measuring the speed at which solid particles drop in a less dense liquid. The grain size is determined by applying Stokes' law,
v: settling velocity (m/s)
g: acceleration due to gravity (m/s²)
Δγ: difference in density between the particles and the suspending liquid (kg/m³)
μ: viscosity of the suspending liquid (Pa·s).

The diameter of the particle or its Stokes diameter is then determined according to formula I:

$$d = \sqrt{} ( \frac{18 μ v}{g Δγ} ) \qquad ( I )$$

According to the invention, sedimentation analysis is carried out using X-rays that measure the absorption of radiation by the suspension at a given height and at a given time depending on the concentration. For suspensions according to the invention, sedimentation analysis makes it possible to determine the slope factor E, which is representative of the slope of a grain size distribution curve for the sizes of the particles in the suspension, in which the particle diameter is represented on the abscissa and the cumulative mass percentage of the particles is represented on the ordinate. The slope factor is therefore high when the grain size distribution for the particle sizes is narrow.

According to the invention, the slope factor E of the mass distribution of particle sizes [(d30/d70)×100] of the suspension S, measured by sedimentation analysis, is greater than 30. According to the invention, the diameters d30 and d70 respectively define the diameters of the particles for which 30% and 70% by weight of the particles have a diameter smaller than the value of d30 and smaller than the value of d70; d30 and d70 are measured using a sedimentation meter, for example a SediGraph 5100 sedimentation meter. When the values d30 and d70 are close, the slope factor E is high and the particle size distribution is narrow.

Preferably for the suspension S according to the invention, the slope factor E is greater than 35, preferably greater than 40.

Preferably according to the invention, the suspension S has a Brookfield viscosity at 25° C., at 100 rpm, measured 1 hour after preparation, of less than 1,000 mPa·s, preferably less than 800 mPa·s. Also preferably according to the invention, the suspension S has a Brookfield viscosity at 25° C., at 100 rpm and after stirring, measured 8 days after preparation, of less than 800 mPa·s, preferably less than 600 mPa·s. Also preferably according to the invention, the suspension S has a Brookfield viscosity at 25° C., at 100 rpm and before stirring, measured 8 days after preparation, of less than 3,000 mPa·s, preferably less than 2,500 mPa·s, more preferentially less than 2,000 mPa·s or less than 1,900 mPa·s.

Preferably, the suspension S uses a single material M or two or three materials M. According to the invention, the material M is synthetic or of natural origin. Preferably, the material M is chosen among alkaline-earth metal carbonate, more preferentially calcium carbonate (natural calcium carbonate or precipitated calcium carbonate), strontium carbonate, magnesium carbonate, barium carbonate, dolomite, kaolin, titanium dioxide, talc, lime, calcium sulphate, barium sulphate. Preferably, the material M is chosen among natural calcium carbonate, precipitated calcium carbonate, magnesium carbonate, dolomite, kaolin, titanium dioxide, talc, lime. Much more preferably, the material M is calcium carbonate.

Thus, essentially according to the invention, the aqueous suspension S and the suspension Sd comprise particles of at least one mineral material M. According to the invention, the concentration of the suspension S or of the suspension Sd is its dry solids content of particles of material M. Preferably according to the invention, the concentration of the suspension S is greater than 70% by weight. Also preferably according to the invention, the concentration of the suspension S is less than 78% by weight or less than 75% by weight.

More preferably according to the invention, the concentration of the suspension S ranges from 70% by weight to 78% by weight or from 70% by weight to 75% by weight. Preferably according to the invention, the concentration of the suspension Sd is less than 55% by weight. Also preferably according to the invention, the concentration of the suspension Sd is greater than 40% by weight, preferably greater than 45% by weight. More preferentially, the concentration of the suspension Sd ranges from 30% to 55% by weight or from 40% to 60% by weight. The concentration of the suspensions S and Sd is measured by weighing an amount of 100 g of suspension from which the water and the volatile substances at room temperature are separated, for example by heating.

Preferably according to the invention, the polymer P is used in an amount ranging from 0.05% to 5% by dry weight, preferentially from 0.3% to 1.0% by dry weight, relative to the dry weight of particulate mineral material M.

According to the invention, the particles of dispersed material M have a median size of less than 50 μm or a median size ranging from 0.05 to 50 μm or a median size of less than 10 μm, preferably less than 5 μm or less than 2 μm, more preferentially less than 1 μm or less than 0.5 μm. Also preferably for the suspension S according to the invention, the material Mis ground in water in the presence of the aqueous dispersion D. Preferably, the ground particles of material M then have a median size of less than 50 μm or a median size ranging from 0.05 to 50 μm or a median size of less than 10 μm, preferably less than 5 μm or less than 2 μm, more preferentially less than 1 μm or less than 0.5 μm. According to the invention, the median size of the particles of material M is measured by sedimentation analysis, for example using a sedimentation meter.

Essentially according to the invention, the suspension S is prepared in the presence of an aqueous dispersion D that comprises the α-sulphonated polymer P. Preferably according to the invention, the polymer P is chosen among an α-ω-disulphonated polymer P1, an α-monosulphonated polymer P2 and combinations thereof.

According to the invention, the polymer P is prepared using the monomer A. Preferably, the monomer A is chosen among acrylic acid, an acrylic acid salt and combinations thereof. Advantageously, the monomer A can be combined with at least one other monomer chosen among vinyl acetate, methyl acrylate, ethyl acrylate, hydroxyethylmethacrylate, hydroxyethylacrylate, hydroxypropylmethacrylate, hydroxypropylacrylate, 2-acrylamido-2-methylpropane sulphonic acid (AMPS), maleic acid, maleic anhydride, itaconic acid and combinations thereof. More advantageously, the monomer A is chosen among acrylic acid, an acid salt and combinations thereof, combined with at least one other monomer chosen among vinyl acetate, methyl acrylate, ethyl acrylate, hydroxyethylmethacrylate, hydroxyethylacrylate, hydroxypropylmethacrylate, hydroxypropylacrylate, 2-acrylamido-2-methylpropane sulphonic acid (AMPS), maleic acid, maleic anhydride, itaconic acid and combinations thereof.

Essentially according to the invention, the polymer P is prepared in the presence of at least one compound T comprising sulphur IV. Preferably, the compound T is chosen among lithium hydrogen sulphite, sodium hydrogen sulphite, potassium hydrogen sulphite, ammonium hydrogen sulphite, calcium di(hydrogen sulphite), magnesium di(hydrogen sulphite) and combinations thereof. Preferentially according to the invention, the compound T is a mono-hydrogen sulphite. Sodium hydrogen sulphite or sodium bisulphite is more particularly preferred.

Preferably according to the invention, the polymerisation reaction is carried out at a temperature above 30° C. and below 100° C., preferably below 90° C., more preferentially below 80° C. or below 75° C.

According to the invention, the polymer A is prepared in the presence of at least one initiator compound. Preferably, the initiator compound is chosen among a peroxide (for example hydrogen peroxide, tert-butyl hydroperoxide), a persulphate (for example sodium persulphate, ammonium persulphate, potassium persulphate), combinations thereof and associations thereof with a metal salt, preferably a metal salt chosen among an iron salt (for example Fe II or Fe III), a copper salt (for example Cu I or Cu II) and combinations thereof.

Advantageously, the polymer P can be partially non-neutralised, preferably non-neutralised by 2 mol % to 35 mol %, more preferentially by 5 mol % to 30 mol %, relative to the number of carboxyl groups. Essentially according to the invention, the polymer P is partially or completely neutralised by means of a combination of at least one monovalent ion and of at least one divalent ion. According to the invention, the carboxyl groups of the polymer P can be partially neutralised at a rate of 70 to 97 mol %, preferably at a rate of 90 to 95 mol %. Preferably, the polymer P is partially neutralised.

According to the invention, the polymer P can be completely or partially neutralised in variable relative molar proportions of monovalent and divalent ions. Preferably according to the invention, the monovalent ion/divalent ion molar proportions are comprised between 90/10 and 10/90 or between 80/20 and 20/80, preferably between 80/20 and 60/40, for example 70/30, 60/40 or 50/50.

Preferably according to the invention, the monovalent ion is chosen among K⁺, Na⁺, Li⁺, NH₄⁺ and combinations thereof. The particularly preferred ion is Nat. According to the invention, the polymer P can be neutralised by means of at least one compound chosen among NaOH, KOH, LiOH and ammonium derivatives. Also preferably according to the invention, the divalent ion is chosen among Ca²⁺, Mg²⁺ and combinations thereof. The particularly preferred ion is Ca²⁺. According to the invention, the polymer P can be neutralised by means of at least one compound chosen among CaO, Ca(OH)₂, MgO, Mg(OH)₂ and combinations thereof.

Preferably, the polymer P can be completely or partially neutralised using a combination of Na⁺ and of Ca²⁺.

Preferably, the polymer P has a weight-average molecular mass Mw, measured by SEC, of less than 20,000 g/mol, preferably less than 15,000 g/mol, less than 10,000 g/mol, more preferentially less than 9,500 g/mol or less than 8,000 g/mol. The polymer P generally has a weight-average molecular mass Mw, measured by SEC, greater than 4,500 g/mol or greater than 5,000 g/mol, preferably greater than 5,500 g/mol or greater than 6,000 g/mol. According to the invention, the weight-average molecular mass Mw of the polymer P therefore advantageously ranges from 4,500 g/mol to 15,000 g/mol, from 4,500 g/mol to 10,000 g/mol, from 4,500 g/mol to 9,500 g/mol or from 4,500 g/mol to 8,000 g/mol. Also advantageously according to the invention, the weight-average molecular mass Mw of the polymer P ranges from 5,000 g/mol to 15,000 g/mol, from 5,000 g/mol to 10,000 g/mol, from 5,000 g/mol to 9,500 g/mol or from 5,000 g/mol to 8,000 g/mol. More advantageously according to the invention, the weight-average molecular mass Mw of the polymer P ranges from 5,500 g/mol to 15,000 g/mol, from 5,500 g/mol to 10,000 g/mol, from 5,500 g/mol to 9,500 g/mol or from 5,500 g/mol to 8,000 g/mol.

Preferably, the polymer P has a polymolecularity index PI, measured by SEC, of less than 4 or ranging from 1.9 to 4; from 1.9 to 3 or from 1.5 to 3; from 1.2 to 2.5 or from 1.9 to 2.9.

According to the invention, the molecular weight or mass of the polymer P is determined by Size Exclusion Chromatography (SEC). A test portion of the polymer dispersion corresponding to 90 mg of dry solids content is placed in a 10 mL flask. Mobile phase is added, together with 0.04% dimethylformamide (DMF), until a total mass of 10 g is reached. The composition of this mobile phase is as follows: NaHCO₃: 0.05 mol/L, NaNO₃: 0.1 mol/L, triethanolamine: 0.02 mol/L, NaN₃ 0.03% by mass. The SEC chain is composed of a Waters 510 isocratic pump with a flow rate set to 0.8 mL/min, of a Waters 717+ sample changer, of an oven containing a Waters Ultrahydrogel Column Guard precolumn 6 cm long and 40 mm in inner diameter, followed by a Waters Ultrahydrogel linear column 30 cm long and 7.8 mm in inner diameter. Detection is provided by means of a Waters 410 RI differential refractometer. The oven is brought to a temperature of 60° C. and the refractometer is brought to a temperature of 45° C. The SEC instrument is calibrated with a series of polyacrylate sodium standards supplied by Polymer Standard Service with a molecular weight at the top of the peak comprised between 900 g/mol and 2,250,000 g/mol and a polymolecularity index comprised between 1.4 and 1.7. The calibration curve is straight-line and takes into account the correction obtained using the flow rate marker: dimethylformamide (DMF). Acquisition and processing of the chromatogram are performed using PSS WinGPC Scientific software v 4.02. The chromatogram obtained is incorporated into the area corresponding to molecular weights of more than 250 g/mol.

Preferably according to the invention, the molar amount of sulphur compound T present within suspension S, preferably the molar amount of sulphur IV, is comprised between 1% and 15%, preferably between 1.5% and 12%, relative to the total molar amount of monomers used. More preferably according to the invention, the molar amount of sulphur compound T present within the suspension S, preferably the molar amount of sulphur IV, is comprised between 1% and 15%, preferably between 1.5% and 12%, relative to the total molar amount of unsaturated groups in the monomers used.

According to the invention, the suspension S comprises at least one compound B chosen among a sulpho-carboxylic acid, a sulpho-carboxylic acid salt and combinations thereof. According to the invention, the compound B is chosen among sulphoarylcarboxylic acids and sulphoalkylcarboxylic acids, in particular 3-sulphopropionic acid, 3-sulpho-2-methylpropionic acid, sulpho-succinic acid, their salts and combinations thereof. The salts of the compound B are generally sodium salt, potassium salt, lithium salt, calcium salt, magnesium salt or ammonium salt.

According to the invention, the molar amount of compound B present within the suspension S is generally less than 25% relative to the molar amount of sulphur IV. Preferably, the molar amount of compound B is less than 20% or more preferentially less than 15% or less than 12% relative to the molar amount of sulphur IV. Generally according to the invention, the molar amount of compound B present within suspension S is greater than 0.2% relative to the molar amount of sulphur IV. In particular, the molar amount of compound B is greater than 2% or greater than 5% relative to the molar amount of sulphur IV. According to the invention, the molar amount of compound B present within the suspension S relative to the molar amount of sulphur IV is therefore generally comprised within the ranges of from 0.2% to 25%, from 2% to 25%, from 5% to 25%, from 0.2% to 20%, from 2% to 20%, from 5% to 20%, from 0.2% to 15%, from 2% to 15%, from 5% to 15%, from 0.2% to 12%, from 2% to 12%, from 5% to 12%.

According to the invention, the polymer P is prepared in the absence of any phosphorus compound. In particular, the polymer P is prepared in the absence of any compound comprising phosphorus in oxidation state I, in particular in the absence of hypophosphorous acid, sodium hypophosphite, potassium hypophosphite, lithium hypophosphite, ammonium hypophosphite, calcium hypophosphite and magnesium hypophosphite; or in the absence of any compound comprising phosphorus in oxidation state III, in particular in the absence of phosphorous acid and of phosphorous acid salt.

The suspension S according to the invention is prepared by grinding the suspension Sd and then concentrating the suspension resulting from the grinding. Preferably according to the invention, the concentration step is carried out by thermal concentration, generally by heating. The heating temperature is generally above 80° C. Preferably, the heating temperature is generally below 95° C. Preferably according to the invention, the concentration step is carried out in the presence of a dispersing agent which is known as such. The dispersing agent according to the invention can comprise a polymer chosen among (meth)acrylic homopolymers or (meth)acrylic copolymers. It can be completely or partially neutralised, for example using Na⁺, Li⁺, Ca²⁺ or Mg²⁺. The molecular mass Mw, measured by SEC, of the polymer in the dispersing agent is generally comprised between 2,000 g/mol and 20,000 g/mol, preferably between 5,000 g/mol and 12,000 g/mol. The dispersing agent can also comprise an acid, for example phosphoric acid.

The invention also relates to the preparation of the suspension S. Thus, the invention provides a method for preparing an aqueous suspension S comprising wet grinding at least one mineral material M in the presence of an aqueous dispersion D comprising:
a) at least one α-sulphonated polymer P prepared in water and in the absence of any phosphorus compound, by a polymerisation reaction of at least one monomer A chosen among acrylic acid, methacrylic acid, an acrylic acid salt, a methacrylic acid salt and combinations thereof, in the presence of at least one initiator compound and of at least one sulphur compound T comprising sulphur in oxidation state IV, and completely or partially neutralised solely by means of a combination of at least one monovalent ion and of at least one divalent ion,
b) at least one compound B chosen among a sulpho-carboxylic acid, a sulpho-carboxylic acid salt and combinations thereof, present in a molar amount of less than 25% relative to the molar amount of sulphur IV.

The preparation of the suspension S according to the invention uses the aqueous dispersion D of the α-sulphonated polymer P as a grinding aid agent for grinding the mineral material M. The invention also relates to this agent. Thus, the invention provides a grinding aid agent comprising an aqueous dispersion D comprising:
a) at least one α-sulphonated polymer P prepared in water and in the absence of any phosphorus compound, by a polymerisation reaction of at least one monomer A chosen among acrylic acid, methacrylic acid, an acrylic acid salt, a methacrylic acid salt and combinations thereof, in the presence of at least one initiator compound and of at least one sulphur compound T comprising sulphur in oxidation state IV, and completely or partially neutralised solely by means of a combination of at least one monovalent ion and of at least one divalent ion,
b) at least one compound B chosen among a sulpho-carboxylic acid, a sulpho-carboxylic acid salt and combinations thereof, present in a molar amount of less than 25% relative to the molar amount of sulphur IV.

This grinding aid agent makes it possible to improve the grinding of the mineral material M in a particularly effective manner. Thus, the invention also provides a method for improving the efficacy of the wet grinding of at least one mineral material M comprising the use, while grinding, of an aqueous dispersion D comprising at least one α-sulphonated polymer P prepared in water and in the absence of any phosphorus compound, by a polymerisation reaction of at least one monomer A chosen among acrylic acid, methacrylic acid, an acrylic acid salt, a methacrylic acid salt and combinations thereof, in the presence of at least one initiator compound and of at least one sulphur compound T comprising sulphur in oxidation state IV, and completely or partially neutralised solely by means of a combination of at least one monovalent ion and of at least one divalent ion, with a reduced level of compound B chosen among a sulpho-carboxylic acid, a sulpho-carboxylic acid salt and combinations thereof, preferably comprising compound B in a molar amount of less than 25% relative to the molar amount of sulphur IV.

The aqueous suspension S obtained from the invention has particularly advantageous properties and can be used in many technical fields, in particular for paper preparation. Thus, the invention provides a method for preparing a mass filler composition for papermaking or a paper coating colour composition comprising the preparation of an aqueous suspension S of mineral particles prepared by wet grinding at least one mineral material M in the presence of an aqueous dispersion D comprising:
a) at least one α-sulphonated polymer P prepared in water and in the absence of any phosphorus compound, by a polymerisation reaction of at least one monomer A chosen among acrylic acid, methacrylic acid, an acrylic acid salt, a methacrylic acid salt and combinations thereof, in the presence of at least one initiator compound and of at least one sulphur compound T comprising sulphur in oxidation state IV, and completely or partially neutralised solely by means of a combination of at least one monovalent ion and of at least one divalent ion,
b) at least one compound B chosen among a sulpho-carboxylic acid, a sulpho-carboxylic acid salt and combinations thereof, present in a molar amount of less than 25% relative to the molar amount of sulphur IV.

This method for preparing paper comprises the use of a suspension S according to the invention, in particular when applying a paper coating colour or when adding a filler composition.

The aqueous suspension S obtained from the invention can also be used to prepare a coating composition, in particular a varnish or a paint. Thus, the invention provides a method for preparing a coating composition comprising:
the preparation of an aqueous suspension S of mineral particles prepared by wet grinding at least one mineral material M in the presence of an aqueous dispersion D comprising:
a) at least one α-sulphonated polymer P prepared in water and in the absence of any phosphorus compound, by a polymerisation reaction of at least one monomer A chosen among acrylic acid, methacrylic acid, an acrylic acid salt, a methacrylic acid salt and combinations thereof, in the presence of at least one initiator compound and of at least one sulphur compound T comprising sulphur in oxidation state IV, and completely or partially neutralised by means of a combination of at least one monovalent ion and of at least one divalent ion,
b) at least one compound B chosen among a sulpho-carboxylic acid, a sulpho-carboxylic acid salt and combinations thereof, present in a molar amount of less than 25% relative to the molar amount of sulphur IV,
mixing the suspension S with at least one binder compound, optionally with at least one compound chosen among a rheology modifying compound and an organic or mineral pigment.

The coating composition according to the invention comprises:
an aqueous suspension S of mineral particles prepared by wet grinding at least one mineral material M in the presence of an aqueous dispersion D comprising:
a) at least one α-sulphonated polymer P prepared in water and in the absence of any phosphorus compound, by a polymerisation reaction of at least one monomer A chosen among acrylic acid, methacrylic acid, an acrylic acid salt, a methacrylic acid salt and combinations thereof, in the presence of at least one initiator compound and of at least one sulphur compound T comprising sulphur in oxidation state IV, and completely or partially neutralised by means of a combination of at least one monovalent ion and of at least one divalent ion,
b) at least one compound B chosen among a sulpho-carboxylic acid, a sulpho-carboxylic acid salt and combinations thereof, present in a molar amount of less than 25% relative to the molar amount of sulphur IV,
at least one binder compound, optionally with at least one compound chosen among a rheology modifying compound and an organic or mineral pigment.

The invention also provides a method for preparing a coating comprising applying a coating composition according to the invention to a substrate.

The invention also provides a method for controlling, preferably for improving or increasing the slope factor E of the mass distribution of particle sizes [(d30/d70)×100] measured by sedimentation analysis, of an aqueous suspension S of mineral particles with a particle concentration ranging from 65 to 80% by weight, comprising:
grinding in water at a concentration ranging from 30 to 60% by weight of an aqueous suspension Sd of at least one particulate mineral material M in the presence of an aqueous dispersion D comprising at least one α-sulphonated polymer P with a molecular mass by weight (Mw), measured by SEC, comprised between 4,000 and 20,000 g/mol and
prepared in water and in the absence of any phosphorus compound, by a polymerisation reaction of at least one monomer A chosen among acrylic acid, methacrylic acid, an acrylic acid salt, a methacrylic acid salt and combinations thereof, in the presence of at least one initiator compound and of at least one sulphur compound T comprising sulphur in oxidation state IV (sulphur IV or S^{IV}), and
completely or partially neutralised by means of a combination of at least one monovalent ion and of at least one divalent ion, then
concentration of the ground suspension Sd.

According to the invention, the particular, advantageous or preferred characteristics of the suspension S according to the invention define methods for its preparation, methods which use it as well as grinding agents which are also particular, advantageous or preferred.

The following examples illustrate the various aspects of the invention.

### Preparation and Characterisation of the Polymer P1 According to the Invention:

In a 1 litre glass reactor equipped with a stirrer, a thermometer and a cooling system, a load comprising 0.006 g of iron sulphate heptahydrate and 380 g of water is prepared at room temperature. Then, 3 loads to be introduced separately and in parallel over three hours are prepared. In a first beaker 623.5 g of acrylic acid are introduced, in a second beaker 3.74 g of sodium persulphate and 46.6 g of water are introduced, and in a third beaker 90.43 g of a 40% by mass aqueous sodium bisulphite solution are introduced. After three hours of addition at 73° C., a clear dispersion of polymer P1 is obtained. This polymer is then partially neutralised by adding milk of lime and sodium hydroxide (pH=5.1) (45Na, 30Ca). The dry solids content of the polymer dispersion P1 is 39.6%. The polymer P1 has an Mw of 6,600 g/mol and a P1 of 2.4.

The compound B and the amount of compound B (mol % relative to the molar amount of sulphur IV of the compound T used) contained in the polymer dispersion are determined by sulphate ion assay and by ¹H NMR and ¹³C NMR analysis of the sulphonated groups of the polymer P and of the compound B.

The sulphate ion levels in the polymer dispersions are determined by ion chromatography. A test portion of about 80 mg of polymer dispersion is introduced into a 15 mL vial. Mobile phase is added to a total mass of 15 g. The composition of the mobile phase is as follows: sodium carbonate: 0.009 mol/L. The ion chromatography chain for the anion assay consists of a Dionex Aquion ion chromatography system with built-in degasser, of which the flow rate is set at 1 mL/min, containing a chemical suppressor, an AG9-HC precolumn, a CG3 metal trap precolumn, an NG1 precolumn and an AG9-HC column. A conductimetric detector is used for detection. The ion chromatography instrument is calibrated with a series of sodium sulphate solution standards. The calibration range is comprised between 0.5 and 100 ppm. The calibration curve is straight-line. The instrument automatically dilutes the samples to ensure that they are within the calibration range. Acquisition and processing of the chromatogram are performed using Chromeleon software 7.2.10.

¹H NMR and ¹³C NMR analyses are carried out using a Bruker AV III HD 500 spectrometer equipped with a 5 mm BBI probe. The polymer samples were dissolved in deuterated water and examined by ¹H NMR and ¹³C NMR using 2D experiments: correlations ¹H/¹³C at ordinary distance and at long distance.

The dispersion D of polymer P1 according to the invention comprises 3-sulphopropionic acid as compound B in an amount of 8 mol % relative to the molar amount of sodium bisulphite.

### Preparation and Characterisation of Aqueous Suspensions S According to the Invention:

Under mechanical stirring using a Rayneri motor, 4,000 g of calcium carbonate (Omyacarb 10 AV Omya) are dispersed in 4,000 g of water in the presence of 0.45% by dry weight relative to the dry weight of dry calcium carbonate in polymer P1. Stirring is continued for 20 minutes.

Then, grinding is carried out using a grinder (Wab Dyno Mill type KDL pilot 1.4 L) containing 2,800 g of ceramic beads (ER 120 S from 0.6 mm to 1.0 mm in diameter-Saint Gobain). The grinding conditions are adjusted so as to obtain a suspension of particles of mineral material of the desired particle size distribution. The concentration of the suspension Sd1 to be ground is 50%+1%. After 75 minutes of grinding, the desired particle size is achieved (75%+1% by weight of particles with a spherical equivalent diameter <1 μm). The particle size characteristics are determined using a SediGraph III 5120 sedimentation meter (Micromeritics, USA).

The particle size distribution of the suspensions of particles of mineral material is measured. This enables the mass fraction to be determined as a percentage of a population of particles with an equivalent spherical diameter of less than 1 μm (esd <1 μm, expressed in %). These measurements are carried out for an aqueous suspension of particles of mineral material diluted to a concentration of approximately 37 g of dry solids content per litre of solution and comprising 4,000 g/mol by Mw of standard sodium polyacrylate at a concentration of 2.25 g sec/L. Each sample is dispersed and sonicated prior to particle size measurement.

The slope factor E of the mass distribution of particle sizes [(d30/d70)×100] is measured, and is equal to 43.

This suspension is then thermally concentrated to a concentration of 71±1% by water evaporation using a Vorwerk instrument in the presence of 0.25% by dry weight relative to the dry weight of dry calcium carbonate of a known dispersing agent comprising phosphoric acid and a sodium polyacrylate, with a molecular mass Mw measured by SEC of 10,000 g/mol.

The suspension S obtained is then characterised by checking its pH at 25° C. and its solids content (SEC, % by weight) using a Précisa scale. Its Brookfield viscosity at 100 rpm denoted BVO (in mPa·s) is measured at 25° C. using a Brookfield DV3T rheometer equipped with a module 3. A stability study is carried out after 8 days of storage of the suspension S in a climate-controlled chamber at 25° C. The viscosity of this suspension S denoted BV8 (in mPa·s) is measured at 25° C. and before stirring at 100 rpm using a Brookfield DV3T rheometer equipped with a module 5.

The suspension S is stirred using a Rayneri mechanical motor for 1 minute at 2,000 rpm before measuring its Brookfield viscosity at 100 rpm denoted BV8a (in mPa·s). The results obtained are shown in Table 1.

TABLE 1

| Polymer | esd | BV0 | BV8 | BV8a | pH | SC |
|---|---|---|---|---|---|---|
| P1 | 75.6 | 512 | 1,530 | 502 | 8.9 | 70.5 |

The use of a polymer P1 according to the invention comprising a controlled amount of compound B makes it possible to effectively control the particle size of the suspension, its slope factor and its viscosity and stability.

1. An aqueous suspension S, comprising:
mineral particles in a concentration in a range of from 65 to 80 wt. %,
wherein a mass distribution of particle sizes of the mineral particles, calculated as
$$( d 30 / d 70 ) \times 100 ,$$
having a slope factor E, measured by sedimentation analysis, that is greater than 30
wherein the aqueous suspension S is prepared by a process comprising:
grinding in water, at a concentration in a range of from 30 to 60 wt. %, a first aqueous suspension Sd, the first aqueous suspension Sd comprising a particulate mineral material M, in the presence of an aqueous dispersion D comprising an α-sulfonated polymer P with a molecular mass by weight (M_{W}), measured by SEC, in a range of from 4,000 and 20,000 g/mol, to obtain a ground suspension Sd; and
concentrating the ground suspension Sd,
wherein the α-sulfonated polymer P is prepared in water and in the absence of any phosphorus compound, by a process comprising
polymerizing a material comprising (A) acrylic acid, methacrylic acid, an acrylic acid salt, and/or a methacrylic acid salt, an initiator compound, and a sulfur compound T comprising sulfur in oxidation state IV, to obtain a first polymer and
at least partially neutralizing the first polymer with a combination comprising a monovalent ion and a divalent ion.

2. The suspension S of claim 1, wherein the slope factor E is greater than 35.

3. The suspension S of claim 1, having a Brookfield viscosity at 25° C. and 100 rpm:
measured 1 hour after preparation, less than 1,000 mPa·s,
after stirring, measured 8 days after preparation, of less than 800 mPa's, or
before stirring, measured 8 days after preparation of less than 3,000 mPa·s.

4. The suspension S of claim 1, wherein the particulate mineral material M is a single material,
wherein the particulate mineral material M is of natural origin,
wherein a concentration of suspension S is greater than 70 wt. % or less than 78 wt. %, or
wherein the α-sulfonated polymer P is present in the aqueous suspension S in a range of from 0.05% to 5 wt. % by dry weight, relative to a dry weight of the particulate mineral material M.

5. The suspension S of claim 1,
wherein particles of ground material M have a median size, measured by sedimentation analysis, of less than 50 μm,
wherein a concentration of the aqueous suspension Sd is greater than 40 wt. %, or
wherein a concentration of the aqueous suspension Sd is less than 55 wt. %.

6. The suspension S of claim 1, wherein the α-sulfonated polymer P comprises an α-ω-disulfonated polymer P1 and/or an α-monosulfonated polymer P2.

7. The suspension S of claim 1,
wherein the α-sulfonated polymer P comprises, in polymerized form, the acrylic acid and/or the acrylic acid salt,
wherein the α-sulfonated polymer P further comprises, in polymerized form, vinyl acetate, ethyl acrylate methyl acrylate, hydroxyethylmethacrylate, hydroxyethylacrylate, hydroxypropylmethacrylate, hydroxypropylacrylate, 2-acrylamido-2-methylpropane sulfonic acid, maleic acid, maleic anhydride, and/or itaconic acid, optionally in salt form,
wherein the α-sulfonated polymer P comprises, in polymerized form, the acrylic acid and/or the acrylic acid salt, and further comprises, in polymerized form, 2-acrylamido-2-methylpropane sulfonic acid, maleic acid, maleic anhydride, and/or itaconic acid, optionally in salt form,
wherein the sulfur compound T comprises lithium hydrogen sulfite, sodium hydrogen sulfite, potassium hydrogen sulfite, ammonium hydrogen sulfite, calcium di(hydrogen sulfite), and/or magnesium di(hydrogen sulfite),
wherein the polymerizing for the α-sulfonated polymer P is carried out at a temperature in a range of from above 30 to below 100° C.,
wherein the initiator compound for the α-sulfonated polymer P comprises a peroxide and/or persulfate, optionally as an association further comprising a metal salt,
wherein the α-sulfonated polymer P is partially non-neutralized,
wherein the α-sulfonated polymer P is at least partially neutralized by a combination comprising (i) K⁺, Na⁺, Li⁺, and/or NH₄⁺, and (ii) Mg²⁺ and/or Ca²⁺,
wherein the α-sulfonated polymer P has a weight-average molecular mass Mw, measured by SEC, of less than 15,000 g/mol,
wherein the α-sulfonated polymer P has a weight-average molecular mass Mw, measured by SEC, greater than 4,500 g/mol, or
wherein the α-sulfonated polymer P has a polymolecularity index PI, measured by SEC, of less than 4.

8. The suspension S of claim 1,
wherein the sulfur compound T is present in a molar amount of from 1 to 15%, relative to total monomers moles in the α-sulfonated polymer P.

9. The suspension S of claim 1, wherein the aqueous dispersion D further comprises a compound B comprising a sulfo-carboxylic acid and/or a sulfo-carboxylic acid salt, present in a molar amount of less than 25% relative to a molar amount of sulfur IV.

10. The suspension S of claim 9,
wherein the compound B is present in less than 20 mol. %, relative to moles of sulfur IV, or
wherein the compound B is present in the aqueous suspension Sd in greater than 0.2 mol. %, relative to the moles of sulfur IV.

11. A method for preparing an aqueous the aqueous suspension S of claim 1, the method comprising:
grinding in water, at a concentration in a range of from 30 to 60 wt. % of the aqueous suspension Sd, a pre-grind material comprising the particulate mineral material M and the aqueous dispersion D comprising the α-sulfonated polymer P.

12. A grinding agent, comprising:
an aqueous dispersion D comprising an α-sulfonated polymer P with a molecular mass by weight (M_{W}), measured by SEC, in a range of from 4,000 to 20,000 g/mol,
wherein the an α-sulfonated polymer P is prepared in water and in the absence of any phosphorus compound, by a process comprising:
polymerizing a starting material comprising acrylic acid, methacrylic acid, an acrylic acid salt, and/or a methacrylic acid salt, an initiator compound, and a sulfur compound T comprising sulfur in oxidation state IV, to obtain a first polymer; and
at least partially neutralizing the first polymer by a combination comprising a monovalent ion and a divalent ion.

13. A method for preparing a mass filler composition suitable for papermaking or a paper coating color composition, the method comprising:
preparing an aqueous suspension S comprising mineral particles with a particle concentration in a range of from 65 to 80 wt. %, a mass distribution of particle sizes of the mineral particles having a slope factor E calculated as
$$( d 30 / d 70 ) \times 100 ,$$
measured by sedimentation analysis, greater than 30; and
mixing the aqueous suspension S with an additive comprising a binding agent, and optionally a rheology modifying agent, a water-retaining agent, an optical brightening agent, an organic pigment, and/or a mineral pigment,
wherein the aqueous suspension S is prepared by a process comprising:
grinding in water, at a concentration in a range of from 30 to 60 wt. % of an aqueous suspension Sd, a pre-grind material comprising a particulate mineral material M in the presence of an aqueous dispersion D comprising an α-sulfonated polymer P with a molecular mass by weight (M_{W}), measured by SEC, in a range of from 4,000 and 20,000 g/mol, to obtain a ground suspension Sd; and
concentrating the ground suspension Sd;
wherein the α-sulfonated polymer P is prepared in water and in the absence of any phosphorus compound, by a process comprising:
polymerizing a starting material comprising acrylic acid, methacrylic acid, an acrylic acid salt, and/or a methacrylic acid salt, an initiator compound, and a sulfur compound T comprising sulfur in oxidation state IV, to obtain a first polymer; and
at least partially neutralizing the first polymer by a combination comprising a monovalent ion and a divalent ion.

14. A method for preparing paper, comprising:
contacting a paper precursor and the aqueous suspension S of claim 1.

15. A method for preparing a coating composition, the method comprising:
preparing an aqueous suspension S comprising mineral particles with a particle concentration in a range of from 65 to 80 wt. %, a mass distribution of particle sizes of the mineral particles having a slope factor E calculated as
$$( d 30 / d 70 ) \times 100 ,$$
measured by sedimentation analysis, greater than 30; and
mixing the aqueous suspension S with an additive comprising a binder compound, and optionally a rheology modifying compound, an organic pigment, and/or a mineral pigment,
wherein the aqueous suspension S is prepared by a process comprising:
grinding in water, at a concentration in a range of from 30 to 60 wt. % of an aqueous suspension Sd, a pre-grind material comprising a particulate mineral material M in the presence of an aqueous dispersion D comprising an α-sulfonated polymer P with a molecular mass by weight (M_{W}), measured by SEC, in a range of from 4,000 and 20,000 g/mol, to obtain a ground suspension Sd; and
concentrating the ground suspension Sd;
wherein the α-sulfonated polymer P is prepared in water and in the absence of any phosphorus compound, by a process comprising:
polymerizing a starting material comprising acrylic acid, methacrylic acid, an acrylic acid salt, and/or a methacrylic acid salt, an initiator compound, and a sulfur compound T comprising sulfur in oxidation state IV, to obtain a first polymer; and
at least partially neutralizing the first polymer by a combination comprising a monovalent ion and a divalent ion.

16. A coating composition, comprising:
preparing an aqueous suspension S comprising mineral particles with a particle concentration in a range of from 65 to 80 wt. %, a mass distribution of particle sizes of the mineral particles having a slope factor E calculated as
$$( d 30 / d 70 ) \times 100 ,$$
measured by sedimentation analysis, greater than 30;
a binder compound; and
optionally, a rheology modifying compound, an organic pigment, and/or mineral pigment,
wherein the aqueous suspension S is prepared by a process comprising:
grinding in water, at a concentration in a range of from 30 to 60 wt. % of an aqueous suspension Sd, a pre-grind material comprising a particulate mineral material M in the presence of an aqueous dispersion D comprising an α-sulfonated polymer P with a molecular mass by weight (M_{W}), measured by SEC, in a range of from 4,000 and 20,000 g/mol, to obtain a ground suspension Sd; and
concentrating the ground suspension Sd;
wherein the α-sulfonated polymer P is prepared in water and in the absence of any phosphorus compound, by a process comprising:
polymerizing a starting material comprising acrylic acid, methacrylic acid, an acrylic acid salt, and/or a methacrylic acid salt, an initiator compound, and a sulfur compound T comprising sulfur in oxidation state IV, to obtain a first polymer; and
at least partially neutralizing the first polymer by a combination comprising a monovalent ion and a divalent ion.

17. A method for preparing a coating, the method comprising:
applying the coating composition of claim 16 to a substrate.

18. A method of controlling, a slope factor E of a mass distribution of particle sizes, calculated as
$$( d 30 / d 70 ) \times 100 ,$$
measured by sedimentation analysis, of an aqueous suspension S comprising mineral particles with a particle concentration in a range of from 65 to 80 wt. %, the method comprising:
grinding in water, at a concentration in a range of from 30 to 60 wt. % of an aqueous suspension Sd, a pre-grind material comprising a particulate mineral material M in the presence of an aqueous dispersion D comprising an α-sulfonated polymer P with a molecular mass by weight (M_{W}), measured by SEC, in a range of from 4,000 and 20,000 g/mol, to obtain a ground suspension Sd; and
concentrating the ground suspension Sd;
wherein the α-sulfonated polymer P is prepared in water and in the absence of any phosphorus compound, by a process comprising:
polymerizing a starting material comprising acrylic acid, methacrylic acid, an acrylic acid salt, and/or a methacrylic acid salt, an initiator compound, and a sulfur compound T comprising sulfur in oxidation state IV, to obtain a first polymer; and
at least partially neutralizing the first polymer by a combination comprising a monovalent ion and a divalent ion.
